(19) United States
(12) Patent Application Publication
(10) Pub. No.: US 2006/0177550 A1
(43) Pub. Date: Aug. 10, 2006

(54) Emulsions

(76) Inventor: John Van De Sype, Semmerzake (BE)

Correspondence Address: CARGILL, INCORPORATED, LAW/24, 15407 MCGINTY ROAD WEST, WAYZATA, MN, 55391, US

(21) Appl. No.: 10/564,496

(22) PCT Filed: Jul. 24, 2003
(86) PCT No.: PCT/US03/23358

§ 371 Date: Jan. 12, 2006

(51) Int. Cl. A23L 2/00

(52) U.S. Cl. 426/330.6

(57) ABSTRACT

There are disclosed lecithin products that can impart emulsion capacity and emulsion stability to emulsions, and also emulsions containing the lecithins that have good emulsion capacity and good emulsion stability.

### CROSS REFERENCE TO RELATED APPLICATION

This application is a continuation-in-part application of U.S. application Ser. No. 10/202,294, that was filed with the United States Patent and Trademark Office on Jul. 23, 2002.

### FIELD OF THE INVENTION

The present invention relates to emulsifiers for use in both water-in-oil emulsions, and in oil-in-water emulsions, and the resulting emulsions.

### BACKGROUND OF THE INVENTION

Emulsions containing lecithin are well known. The lecithin is used in the emulsions, as a surfactant or as an emulsifier. Emulsion capacity and emulsions stability are characteristics of emulsions that are important, and, accordingly, it would be desirable to provide emulsions that have improved emulsions capacity and emulsion stability characteristics.

### SUMMARY OF THE INVENTION

The present invention relates to lecithins of a specific type that are useful in preparing emulsions having improved emulsion capacity and emulsion stability characteristics. The lecithin products of the present invention are in a first embodiment described as membrane separated lecithin having a ratio of alkali metals to alkaline earth metals, ranging from greater than 0 to about 10, and that impart emulsion capacity and/or emulsion stability to emulsions. In a second embodiment, the lecithin products of the present invention are described as having a ratio of alkali metals to alkaline earth metals, ranging from about 1.6 to about 3.0, and that import emulsion capacity and/or emulsion stability to emulsions.

The present invention also relates to emulsions comprising from about 1 to about 99% by weight of a vegetable oil, from about 1 to about 99% by weight of an aqueous phase, and from greater than 0 to about 1% by weight of the specific lecithin mentioned above, based on the amount of vegetable oil utilized.

### DETAILED DESCRIPTION OF THE INVENTION

The present invention relates to lecithins of a specific type that are useful in preparing emulsions having improved emulsion capacity and emulsion stability characteristics. The lecithin products of the present invention are in a first embodiment described as membrane separated lecithin having a ratio of alkali metals to alkaline earth metals, ranging from greater than 0 to about 10, and that impart emulsion capacity and/or emulsion stability to emulsions. In a second embodiment, the lecithin products of the present invention are described as having a ratio of alkali metals to alkaline earth metals, ranging from about 1.6 to about 3.0, and that import emulsion capacity and/or emulsion stability to emulsions.

In determining the content of the alkali metals and alkaline earth metals of the lecithin product, the following test procedure is used.

Elemental Analysis Standard Procedure SRC

Elemental analysis was performed by Inductively Coupled Plasma-Emission Spectroscopy (ICP-ES) with target elements of aluminum, calcium, chromium, iron, lead, magnesium, nickel, potassium, phosphorus, silicon, sodium, and zinc. This analysis was performed according to the American Oil Chemists' Society (AOCS) Official Method Ca 20-99. Each sample was weighed on an analytical balance to the nearest 0.0001 g. Because of the range of concentration, two dilution levels are required. Approximately 0.8 g of sample was weighted out and recorded. To the sample approximately 4.2 g of kerosene was weighted and recorded. The sample/kerosene mixture was vortexed until the sample is completely dissolved. Approximately 4.2 g mineral oil was added to the sample/kerosene solution and recorded. This concentration is used to analyze the lower level elements, Al, Cr, Fe, Pb, Na, Ni, Si, and Zn. For the higher concentration elements, Ca, Mg, P and K, another dilution is made by taking approximately 0.5 g of the first dilution, recording the weight, and adding approximately 9.5 g of a 50/50 kerosene/mineral oil and record the total weight. All of the final dilutions are mixed until homogeneous. The samples are placed into a heated, 40° C., sample hot plate along with the standards and allowed to come to temperature, approximately 10 minutes, prior to the introduction into the ICP. Samples were run in triplicate.

Calculation:

The ICP data is reported typically as ppm calcium, magnesium, potassium, sodium, and phosphorous, along with other metals. The ppm values are divided by the atomic weight of the respective element (Ca:40, K:39, P:31 and Mg:24) and the atomic equivalents are used to calculate the ratio of monovalent to divalent (alkali metals to alkaline earth metals).

The present invention also relates to emulsions comprising greater than 0 to about 99% by weight of a vegetable oil, greater than 0 to about 99% by weight of an aqueous phase, and greater than 0 to about 99% by weight, preferably from greater than 0 to about 1% by weight of the specific lecithin mentioned above, based on the amount of vegetable oil utilized.

The lecithin products of the present invention may be prepared by any suitable manner. For example, a vegetable oil miscella may be passed through a membrane, preferably polymeric or semi-permeable, to obtain a retentate and a permeate. The lecithin products are in the retentate. Exemplary of such methods are those appearing in U.S. Pat. No. 6,207,209 to Jirjis, et al.; U.S. Pat. Nos. 4,496,498 and 4,533,501 to Sen Gupta. Specific examples describing the preparation of lecithin products of the invention are provided as follows:

### Example A

Two samples of miscella were prepared by using the present technique. Miscella samples were obtained from two different oil seeds plants.

A membrane was conditioned and used for removing phospholipids from each of the two samples of miscella. The membrane purchased was a PAN membrane from Osmonics, Inc. The membrane can be characterized as having an average pore size of 0.3 micron, and in the form of a spiral wound 25 inch×40 inch membrane element. The membrane was conditioned by soaking the membrane in an intermediate solvent (propanol) for 24 hours. Then the membrane was soaked in mixture of intermediate solvent (propanol) and extraction solvent (hexane) for 24 hours. Finally, the membrane was soaked in extraction solvent (hexane) for 24 hours.

The two samples of miscella were individually processed. For the soybean oil miscella, the test was conducted at retentate concentration of 10× of the feed concentration and the permeate rate of 10× concentration was 100 liter/hour m². For the corn miscella, the test was conducted at retentate concentration of 7.4× of the feed at a permeate rate of 80 liter/hour m².

### Example B

Samples of soybean oil miscella were taken on different days and were treated by using the present technique.

Spiral wound 8 inch×40 inch QX membranes were purchased from Osmonics, Inc. The membranes were conditioned and used for removing phospholipids by soaking them in an intermediate solvent (100% isopropanol) for 12 hours. At 6 hours, the intermediate solvent was recirculated at a flow rate of 15 m³/hour per element and forced through the membrane pores for about 15 minutes using a pump (this recirculation or forcing through is referred to as “forced Permeation” for purposes of the Example B). Then the resulting membrane was soaked in a 50:50 mixture of intermediate solvent (100% isopropanol) and extraction solvent (100% commercial hexane) for 12 hours. After 6 hours this soaking included recirculation at a flow rate of 15 m³/hour per element and forced permeation for about 15 minutes. Finally, the resulting membranes were soaked in extraction solvent (100% commercial hexane) for 12 hours, also with recirculation and forced permeation of the extraction solvent at 6 hours for about 15 minutes with 15 m³/hour recirculation flow. The resulting membranes treated with this process are “conditioned membranes” for purposes of this Example B.

The soybean miscella containing about 75 wt. % hexane, 24.3 wt. % crude oil, and 0.7 wt. % phospholipids, was passed through the first conditioned membrane at a trans-membrane pressure of 4 Kgf/cm² at a rate of 0.6 m³/hour per element. The resulting retentate stream had about 7 wt. % phospholipids and 23 wt. % oil (i.e., the test was conducted at retentate concentration of 10× of the feed concentration). Excess hexane was added to this retentate in the proportion of two (2) portions of hexane to one (1) portion of retentate resulting in a stream containing 88 wt. % hexane. This retentate stream was passed through a second conditioned membrane at a trans-membrane pressure of 4 Kgf/cm² at a rate of 0.35 m³/hour per element, resulting in a retentate stream having about 65 wt. % hexane, 23 wt. % phospholipids and 12 wt. % oil which is equivalent to lecithin free of hexane with 66% acetone insolubles. This retentate stream was desolventized at a rate of 1800 kg/hour, 95° C. and 260 mm Hg absolute pressure. The resulting concentration of hexane was 5%. The retentate stream was further desolventized at a temperature of 110° at an absolute pressure of 20 mm Hg and sparge stream of 80 kg/hour by using a stripper to product 600 kg/hour of lecithin product with less than 5 ppm of hexane.

Any vegetable oil, which may be solid or liquid at ambient temperature, can be used in the present emulsions. Suitable vegetable oils for use include, for example, soybean oil, sunflower oil, rapeseed oil, cottonseed oil, olive oil, corn oil. ground nut oil, safflower oil, linola oil, linseed oil, palm oil, coconut oil, all of which may be partially or completely hydrogenated or modified otherwise, and mixtures thereof. Particularly useful are soybean oil and partially hydrogenated soybean oil. Suitable oils of animal origin for use include, for example, butter fat and fish oil.

Any suitable aqueous phase may be used. This includes water, any dilute or concentrated aqueous solution that may contain any solute, and a mixture. Preferred for use is water.

The emulsions of the present invention may be prepared by any known technique. In this respect, there are described two (2) procedures for preparing the emulsions herein, in connection with the preparation of emulsions for determination of the properties of emulsion capacity and emulsion stability.

The emulsions of the present invention are expected to be useful in all applications where conventional emulsions are utilized. Exemplary of such uses include agriculture, pharmaceuticals, cosmetics, food and the like.

The following examples are presented to illustrate the present invention and to assist one of ordinary skill in making and using the same. The examples are not intended in any way to otherwise limit the scope of the invention.

### EXAMPLES

In carrying out the following example, the following test procedures were used:

In determining the emulsion capacity of an emulsion of the present invention, the following test procedure is utilized.

(1) One (1) gram of the lecithin is mixed with 99 grams of refined deodorized soybean oil available from Cargill, Inc.;

(2) Fifty (50) grains of the resulting solution is weighed into a 600 ml. Pyrex beaker.

(3) The solution is mixed in a RZR 2102 mixer, available from Heldolph Company, Germany, at room temperature, and at 1700 rpm (revolutions per minute) for one (1) minute;

(4) Demineralized water is added in the vortex of the mixing using a Watson Marlow peristaltic pump, model 5058, at a rate of 115 ml./min., until the emulsion breaks. Breaking of the emulsion is defined generally, for example by the NRT Science and Technology Committee, as the combined sedimentation and coalescence of emulsified drops of a dispersed phase such that the drops will settle out of the carrier liquid. The breaking of the emulsion is also referred to as the point where a water-in-oil emulsion changes to an oil-in-water emulsion. This breaking of the emulsion can be noticed visually in that the viscosity of the emulsion changes from high to a low watery solution. Further, the breaking of the emulsion can be heard, in that the sound changes while stirring occurs. Also, the mixing is no longer controllable, and spattering out of the beaker occurs. At this point, the water is no longer absorbed into the emulsion;

(5) The amount of water added is measured by reading the value directly from the balance; and

(6) Calculating Emulsion Capacity (EC) by the formula of EC=weight of water added×2=grams water added per one (1) gram of lecithin.

Emulsion Stability (ES)

The emulsion stability test provides a characterization of the effectiveness of a lecithin to form stable water-in-oil emulsions and/or oil-in-water emulsions.

(a) In evaluating water-in-oil emulsions, there were evaluated six (6) emulsions having varying proportions of oil and water as follows:
120 g soybean oil and 30 g water
105 g soybean oil and 45 g water
90 g soybean oil and 60 g water
75 g soybean oil and 75 g water
60 g soybean oil and 90 g water
40 g soybean oil and 110 g water
   In each of the six (6) evaluations, the lecithin used was membrane separated, had a content of about 35-40% oil, and had a ratio of alkali metal to alkaline earthmetal of about 2.4

The test procedure is carried out as follows:

(1) Mix 1% by weight of the lecithin in refined deodorized soybean oil, available from Cargill, Inc., until the lecithin is dissolved;

(2) Weigh the above mentioned amount of the solution in a 600 ml Pyrex beaker, to the nearest 0.01 g.;

(3) Mix the solution with a Model RZR 2102 mixer, available from Heldolph Company, Germany, at 25° C., at 1700 rpm, for one (1) minute;

(4) After one (1 ) minute, the above mentioned amount of Demineralized water is added in the vortex of the mixing using a Watson Marlow peristaltic pump, model 5058, at a rate of 115 ml/minute until the total amount of water is added;

(5) Mix for a further one (1) minute at 1700 rpm, and pour 100 ml of the emulsion into a graduated cylinder;

(6) As the emulsion destabilization occurs, water will begin to separate at the bottom of the cylinder. The layer of water separation at the bottom of the cylinder is recorded at times of 5, 10, 15, 30, 60, 90, 120, 150, 180 and 240 minutes, as well as 12, 24 and 48 hours.

(7) The emulsion stability (ES) is calculated by the recordings. It is noted that the emulsion is more stable when there is less water separation per unit of time.

The test is repeated for the emulsions having the different ratios of water and oil. The results are reported in the Table of data below.

In evaluating oil-in-water emulsions, there were evaluated six (6) emulsions having varying proportions of oil and water as follows:
30 g soybean oil and 120 g water
45 g soybean oil and 105 g water
60 g soybean oil and 90 g water
75 g soybean oil and 75 g water
90 g soybean oil and 60 g water
110 g soybean oil and 40 g water

In each of the six (6) evaluations, the lecithin used was membrane separated, had a content of about 35-40% oil, and had a ratio of alkali metal to alkaline earthmetal of about 1.9.

The test procedure is carried out as follows:

(1) Mix 1% by weight of the lecithin in refined deodorized soybean oil, available from Cargill, Inc., until the lecithin is dissolved;

(2) Weigh the above mentioned amount of the Demineralized water at 25° C. in a 600 ml Pyrex beaker, to the nearest 0.01 g.;

(3) Mix the water with a Model RZR 2102 mixer, available from Heldolph Company, Germany, at 25° C., at 1700 rpm, for 1 minute;

(4) After one (1) minute, the above mentioned amount of lecithin/soybean oil solution is added in the vortex of the mixing using a Watson Marlow peristaltic pump, model 5058, at a rate of 115 ml/minute until the total amount of the lecithin/soybean oil solution is added;

(5) Mix for a further one (1) minute at 1700 rpm, and pour 100 ml of the emulsion into a graduated cylinder;

(6) As the emulsion destabilization occurs, the oil will begin to separate at the top of the cylinder. The layer of soybean oil separation at the bottom of the cylinder is recorded at times of 5, 10, 15, 30, 60, 90, 120, 150, 180 and 240 minutes, as well as 12, 24 and 48 hours.

(7) The emulsion stability (ES) is calculated by the recordings. It is noted that the emulsion is more stable when there is less oil separation per unit of time.

The test is repeated for the emulsions having the different ratios of water and oil. The results are reported in the Table of data below.

In respect of the emulsion capacity of the emulsions, there were carried out six (6) runs utilizing the specified lecithin. The values for the Emulsion Capacity (EC) of the emulsions were 307, 332, 339, 348 and 366 grams water per gram of lecithin. It may be observed from this data that the water-in-oil emulsions of the present invention, are characterized by a high level of emulsion capacity, exceeding a value of 300 grams water per gram of lecithin.

TABLE
EMULSION STABILITY

| | Ratio | | | | | | | | | | | |
|---|---|---|---|---|---|---|---|---|---|---|---|---|
| | Oil and | | | | | | | | | | | |
| Emulsion | Water | 5 min | 10 min | 15 min | 30 min | 60 min | 90 min | 120 min | 150 min | 180 min | 240 min | 12 hrs |
| Water in oil emulsion | | LAYER OF WATER SEPARATION | | | | | | | | | | |
| 120 g oil/ | 80/20 | 0 | 0 | 0 | 0 | 0 | 0 | 0 | 0 | 0 | 0 | 0 |
| 30 g water | | | | | | | | | | | | |
| 105 g oil/ | 70/30 | 0 | 0 | 0 | 0 | 0 | 0 | 0 | 0 | 0 | 0 | 0 |
| 45 g water | | | | | | | | | | | | |
| 90 g oil/ | 60/40 | 0 | 0 | 0 | 0 | 0 | 0 | 0 | 0 | 0 | 0 | 0 |
| 60 g water | | | | | | | | | | | | |
| 75 g oil/ | 50/50 | 0 | 0 | 0 | 0 | 0 | 0 | 0 | 0 | 0 | 0 | 0 |
| 75 g water | | | | | | | | | | | | |
| 60 g oil/ | 40/60 | 0 | 0 | 0 | 0 | 0 | 0 | 0 | 0 | 0 | 0 | 0 |
| 90 g water | | | | | | | | | | | | |
| 40 g oil/ | 27/73 | 0 | 0 | 0 | 0 | 0 | 0 | 0 | 0 | 0 | 0 | 0 |
| 110 g water | | | | | | | | | | | | |
| Oil in water emulsion | | LAYER OF OIL SEPARATION | | | | | | | | | | |
| 120 g water/ | 20/80 | 19 | 19 | 19 | 19 | 19 | 19 | 19 | 19 | 19 | 19 | 19 |
| 30 g oil | | | | | | | | | | | | |
| 105 g water | 30/70 | 28 | 28 | 28 | 28 | 28 | 28 | 28 | 28 | 28 | 28 | 28 |
| 45 g oil | | | | | | | | | | | | |
| 90 g water/ | 40/60 | 27 | 37 | 37 | 37 | 37 | 38 | 38 | 38 | 38 | 38 | 40 |
| 60 g oil | | | | | | | | | | | | |
| 75 g water/ | 50/50 | 31 | 33 | 34 | 35 | 35 | 35 | 35 | 35 | 35 | 35 | 36 |
| 75 g oil | | | | | | | | | | | | |
| 60 g water/ | 60/40 | 0 | 0 | 0 | 0 | 0 | 0 | 0 | 0 | 0 | 0 | 44 |
| 9O g oil | | | | | | | | | | | | |
| 40 g water/ | 73/27 | 0 | 0 | 0 | 0 | 0 | 0 | 0 | 0 | 0 | 0 | 68 |
| 110 g oil | | | | | | | | | | | | |

From the above data it is apparent that all of the water-in-oil emulsions tested are characterized by having good levels of stability as evidenced by data showing no separation for a period of time up to 72 hours.

The data in the Table showing the results for oil-in-water emulsions having the same lecithin, but having varying levels of oil and water, is not as good as that of the water-in-oil emulsions. As the data indicates, for the oil-in-water emulsions, the better emulsion stability is associated with emulsions having at least a ratio of oil to water of at least 60:40. When the oil-in-water emulsions have a ratio of at most 50:50, the emulsion exhibit more oil separation per unit of time.

The invention has been described with reference to various specific and illustrative embodiments and techniques. However, one skilled in the art will recognize that many variations and modifications may be made while remaining within the spirit and scope of the invention.

We claim:

1. A lecithin product comprising a membrane separated lecithin having a ratio of alkali metals to alkaline earth metals, ranging from greater than 0 to about 10, and that imparts emulsion capacity and emulsion stability to emulsions.

2. The lecithin product of claim 1 that imparts emulsion capacity of greater than 300 grams water per gram of lecithin.

3. The lecithin product according to claim 1 wherein the ratio of the alkali metals to alkaline earth metals ranges from greater than 0 to about 5.

4. A lecithin product comprising a lecithin having a ratio of alkali metals to alkaline earth metals, ranging from about 1.6 to about 3.0, and that imparts emulsion capacity and emulsion stability to emulsions.

5. The lecithin product according to claim 1 wherein the ratio of the alkali metals to alkaline earth metals ranges from about 1.8 to about 2.8.

6. The lecithin product of claim 4 that imparts emulsion capacity of greater than 300 grams water per gram of lecithin.

7. An emulsion comprising from greater than 0 to about 99 weight % of a vegetable oil, from greater than 0 to about 99 weight % of an aqueous phase, and from greater than 0 to about 99% by weight of a lecithin product comprising a membrane separated lecithin having a ratio of alkali metals to alkaline earth metals, ranging from greater than 0 to about 10, and that imparts emulsion capacity and emulsion stability to emulsions.

8. The emulsion according to claim 7 wherein the lecithin product has a ratio of the alkali metals to alkaline earth metals ranging from greater than 0 to about 5.

9. An emulsion comprising greater than 0 to about 99 weight % of a vegetable oil, from greater than 0 to about 99 weight % of an aqueous phase, and from greater than 0 to about 99% by weight of a lecithin product having a ratio of alkali metals to alkaline earth metals, ranging from about 1.6 to about 3.0, and that imparts emulsion capacity and emulsion stability to emulsions.

10. The emulsion according to claim 9 wherein the lecithin product has a ratio of alkali metals to alkaline earth metals ranging from about 1.8 to about 2.8.

11. The emulsion according to claim 6 that is a water-in-oil emulsion.

12. The emulsion according to claim 6 that is an oil-in-water emulsion.

13. The emulsion according to claim 9 that is a water-in-oil emulsion.

14. The emulsion according to claim 9 that is an oil-in-water emulsion.
